(19) United States
(12) Patent Application Publication
(10) Pub. No.: US 2014/0343947 A1
(43) Pub. Date: Nov. 20, 2014

(54) METHODS AND SYSTEMS FOR MANAGING DIALOG OF SPEECH SYSTEMS

(71) Applicant: GM GLOBAL TECHNOLOGY OPERATIONS LLC, Detroit, MI (US)

(72) Inventors: UTE WINTER, PETACH TIQWA (IL); TIMOTHY GROST, CLARKSTON, MI (US)

(73) Assignee: GM GLOBAL TECHNOLOGY OPERATIONS LLC, Detroit, MI (US)

(21) Appl. No.: 14/262,183

(22) Filed: Apr. 25, 2014

Related U.S. Application Data
(60) Provisional application No. 61/823,761, filed on May 15, 2013.

(51) Int. Cl. G10L 17/22

(52) U.S. Cl. CPC G10L 17/22
USPC 704/270.1

(57) ABSTRACT

Methods and systems are provided for managing speech dialog of a speech system. In one embodiment, a method includes: receiving at least one first utterance from a user of the speech system; determining a user interaction style based on the at least one first utterance; and generating feedback to the user based on the interaction style.

### RELATED APPLICATION

This application claims the benefit of U.S. Provisional Application No. 61/823,761 filed May 15, 2013.

### TECHNICAL FIELD

The technical field generally relates to speech systems, and more particularly relates to methods and systems for managing dialog within a speech system based on a user interaction style.

### BACKGROUND

Vehicle speech recognition systems perform speech recognition or understanding of speech uttered by occupants of the vehicle. The speech utterances typically include commands that communicate with or control one or more features of the vehicle or other systems that are accessible by the vehicle. A speech dialog system generates spoken commands in response to the speech utterances. In some instances, the spoken commands are generated in response to the speech recognition needing further information in order to perform the speech recognition. In other instances, the spoken commands are generated as a confirmation of the recognized command. Typically, the spoken commands are based on a particular interaction style. The interaction style may be set during production of the speech recognition system or may be preconfigured by a user before use of the speech recognition system. The preselected interaction style may not be pleasing to all users.

Accordingly, it is desirable to provide improved methods and systems for managing a speech dialog. Accordingly, it is further desirable to provide methods and systems for adapting the speech dialog based on a user interaction style. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for managing speech dialog of a speech system. In one embodiment, a method includes: receiving at least one first utterance from a user of the speech system; determining a user interaction style based on the at least one first utterance; and generating feedback to the user based on the interaction style.

In another embodiment, a system includes a first module that receives at least one first utterance from a user of the speech system and that determines a user interaction style based on the at least one first utterance. The system further includes a second module that generates feedback to the user based on the interaction style.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIG. 2 is a dataflow diagram illustrating a speech system in accordance with various exemplary embodiments; and

FIG. 3 is a flowchart illustrating a speech method that may be performed by the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments of the present disclosure a speech system 10 is shown to be included within a vehicle 12. In various exemplary embodiments, the speech system 10 provides speech recognition or understanding and a dialog for one or more vehicle systems through a human machine interface module (HMI) module 14. Such vehicle systems may include, for example, but are not limited to, a phone system 16, a navigation system 18, a media system 20, a telematics system 22, a network system 24, or any other vehicle system that may include a speech dependent application. As can be appreciated, one or more embodiments of the speech system 10 can be applicable to other non-vehicle systems having speech dependent applications and thus, is not limited to the present vehicle example.

The speech system 10 and/or the HMI module 14 communicate with the multiple vehicle systems 14-24 through a communication bus and/or other communication means 26 (e.g., wired, short range wireless, or long range wireless). The communication bus can be, for example, but is not limited to, a controller area network (CAN) bus, local interconnect network (LIN) bus, or any other type of bus.

The speech system 10 includes a speech recognition module 32, a dialog manager module 34, and a speech generation module 35. As can be appreciated, the speech recognition module 32, the dialog manager module 34, and the speech generation module 35 may be implemented as separate systems and/or as a combined system as shown. In general, the speech recognition module 32 receives and processes speech utterances from the HMI module 14 using one or more speech recognition techniques that rely on semantic interpretation and/or natural language understanding. The speech recognition module 32 generates one or more possible results from the speech utterance (e.g., based on a confidence threshold) to the dialog manager module 34.

The dialog manager module 34 manages an interaction sequence and a selection of speech prompts to be spoken to the user based on the results. In various embodiments, the dialog manager module 34 determines a next speech prompt to be generated by the system in response to the user's speech utterance. The dialog manager module 34 then detects a particular interaction style of the user in the speech utterance and selectively adapts the next speech prompt based on the interaction style. The adapted speech prompt is converted into a spoken prompt by the speech generation module 35 and presented to the user via the HMI module 14. As can be appreciated, such adaptation methods may be implemented as part of other modules (e.g., as a separate module or part of another module) of the speech system 10. For exemplary purposes, the disclosure will be discussed in the context of the dialog manager module 34 implementing the adaptation methods.

As an example, if a speech utterance from a user is recognized as:
User: “John Smith on his mobile.”
   The dialog manager module 34 detects an “efficient” interaction style of the user and adapts a next speech prompt to the user to be straight to the point (efficient), such as:
System: “Calling John Smith on his mobile.”

As another example, if a speech utterance from the user may be recognized as:
User: “I would like to call John Smith on his mobile.”
   The dialog manager module 34 detects an “interactive” (more wordy; less to the point) interaction style of the user and adapts a next speech prompt to the user to be of a similar style—interactive, such as:
System: “Got it! I'm calling John Smith on his mobile.”
   As will be discussed in more detail below, the dialog manager module 34 can detect various interaction styles, and the “interactive” style and the “efficient” style are merely provided for exemplary purposes. In various embodiments, the dialog manager module 34 may further adapt other non-speech related feedback (e.g., haptic or visual) to the user based on the interaction style. The non-speech related feedback may be associated with a control feature or other feature of the vehicle systems 14-24.

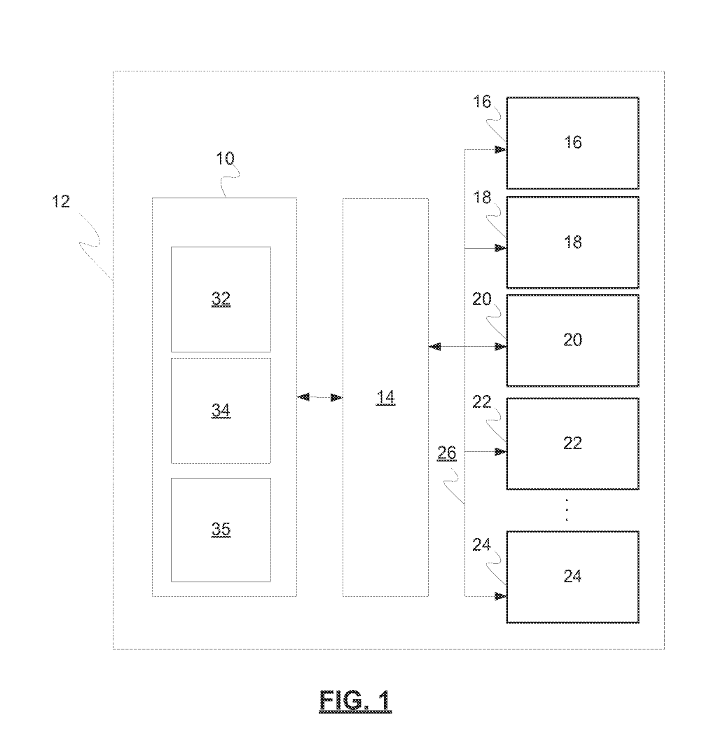

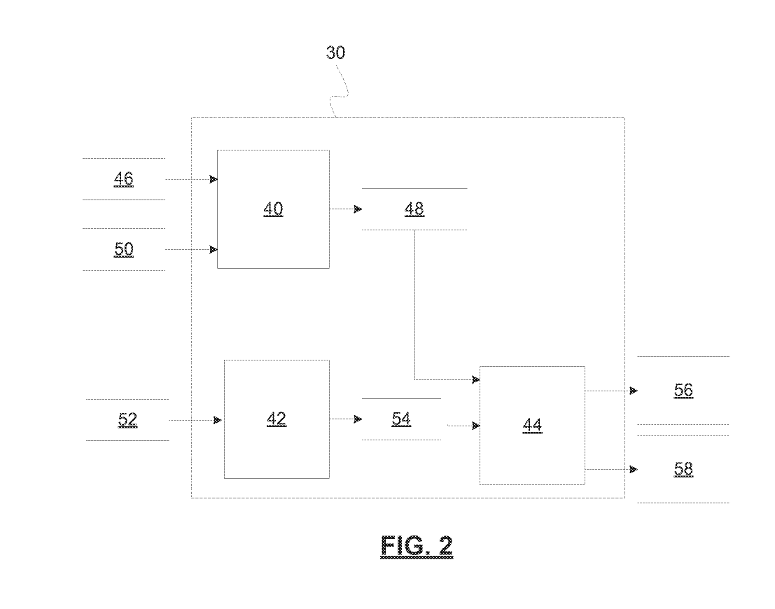

Referring now to FIG. 2 and with continued reference to FIG. 1, a dataflow diagram illustrates the dialog manager module 34 in accordance with various exemplary embodiments. As can be appreciated, various exemplary embodiments of the dialog manager module 34, according to the present disclosure, may include any number of sub-modules. In various exemplary embodiments, the sub-modules shown in FIG. 2 may be combined and/or further partitioned to similarly manage the speech dialog and/or other feedback. In various exemplary embodiments, the dialog manager module 34 includes a style classification module 40, a feedback manager module 42, and an adaptation module 44.

The style classification module 40 receives as input a speech utterance 46 that is either provided by the user through the HMI module 14 or that is a result of the speech recognition module 32. As can be appreciated, the speech utterance 46 may be any partial or full data representation of a speech utterance. The style classification module 40 processes the speech utterance 46 using one or more style processing methods to determine one or more interaction styles 48 of the speech utterance 46.

For example, the style classification module 40 may include one or more predefined interaction styles such as, but not limited to, an efficient style, an interactive style, an aged style, a youth style, an informal style, a formal style, or any other interaction style that may or may not be defined based on the demographics of the user. In another example, the interaction styles may be learned through iterations of the user interacting with the system. Whether the interaction styles are learned or predefined, the style processing methods process the speech utterance 46 based on parameters (e.g. either learned or predefined) that are associated with the interaction styles. For example, predefined parameters associated with the efficient style can include, but are not limited to, a number of dialog turns, an interaction time, a command length, and a variation in words. In another example, predefined parameters associated with the interactive style can include, but are not limited to, a variation in words, a command length, a use of certain types of words, and an indicator of a use of a system name.

In various embodiments, the style classification module 40 may further receive as input user data 50 indicating gestures, expressions, or demographics of the user. As can be appreciated, the user data 50 may be sensed directly from the user by one or more sensor systems of the vehicle 12 (e.g., when the user actively or passively interacts with a system) or may be configured by the user using one or more configuration systems of the vehicle 12. The style classification module 40 processes the user data 50 in addition to the speech utterance 46 to determine the one or more interaction styles 48. For example, parameters of the style processing methods may be set based on gestures, expressions, or demographics of a user and the style processing methods use these parameters to process the user data 50.

The feedback manager module 42 receives as input a speech utterance 52. The speech utterance 52 in this case is a result from the speech recognition module 32 or any other partially or fully processed data representation of a speech utterance. The feedback manager module 42 selects a speech prompt 54 based on the speech utterance 52. For example, if the results indicate that one or more parts of the speech utterance 52 were not recognized, the feedback manager module 42 may select a speech prompt 54 that requests further information from the user. In another example, if the results indicate a certain confidence in the recognition, then the feedback manager module 42 may select a speech prompt 54 that confirms the information in the speech utterance.

The adaptation module 44 receives as input the speech prompt 54 and the interaction style(s) 48. The adaptation module 44 performs one or more adaptation methods on the speech prompt 54 based on the detected interaction style(s) 48. The adaptation methods modify the speech prompt 54 such that it conforms to or reciprocates the interaction style(s) 48. The adaptation methods may modify the speech prompt 54 based on the same or similar parameters associated with the detection of the interaction style(s) 48 and/or other predefined or learned parameters. For example, if the interaction style 48 is efficient, and the speech prompt 54 is a confirmation prompt, then the confirmation prompt is modified based on parameters that cause the prompt to be efficient, with short and concise language. In another example, if the interaction style 48 is interactive, and the speech prompt 54 is a confirmation prompt, then the confirmation prompt is modified based on parameters that cause the prompt to be more interactive, with more verbose language. In various embodiments, the speech prompt 54 may be modified based on parameters and language that are learned from the user and/or based on predefined parameters and language.

Once the speech prompt 54 has been adapted, the adaptation module 44 then generates the adapted speech prompt 56 for use by the speech generator module 35.

In various embodiments, the adaptation module 44 further adapts other non-speech feedback 58 based on the interaction style(s) 48. For example, the adaptation module 44 adapts haptic feedback, voice feedback, sound feedback, and/or visual feedback based on the interaction style 48. The non-speech feedback 58 may be, for example, associated with a feature of the vehicle system 14-24 in which the dialog is taking place.

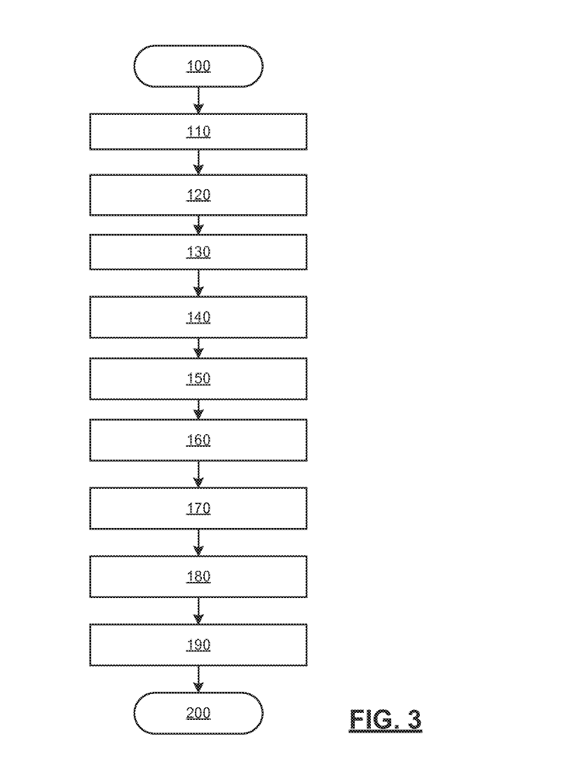

Referring now to FIG. 3, a flowchart illustrates a speech method that may be performed by the speech system 10 in accordance with various exemplary embodiments. As can be appreciated in light of the disclosure, the order of operation within the method is not limited to the sequential execution as illustrated in FIG. 3, but may be performed in one or more varying orders as applicable and in accordance with the present disclosure. As can further be appreciated, one or more steps of the method may be added or removed without altering the spirit of the method.

As shown, the method may begin at 100. The speech utterance 46 is received at 110. One or more speech recognition methods are performed on the speech utterance 46 to determine a result at 120. Optionally, the user data 50 is received at 130. The results and, optionally, the user data 50 are processed at 140 based on one or more style processing methods to determine an interaction style(s) 48. A speech prompt 54 is determined based on the results of the speech utterance 52 at 150. The speech prompt 54 is adapted at 150 based on the interaction style(s) 48 at 160. Optionally, other feedback is adapted based on the interaction style(s) 48 at 170. Thereafter, the adapted speech prompt 56 is converted to speech and generated to the user at 180, and optionally, the adapted other feedback 58 is generated to the user at 190. The method may end at 200.

As can be appreciated, in various embodiments the method may iterate for any number of speech utterances provided by the user, or the method may maintain the specific interaction style for a set period of time (e.g., during current operation of the vehicle) or for X number of speech utterances uttered by a user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for managing speech dialog of a speech system, comprising:
receiving at least one first utterance from a user of the speech system;
determining a user interaction style based on the at least one first utterance; and
generating feedback to the user based on the interaction style.

2. The method of claim 1, further comprising:
determining a next speech prompt based on the first utterance; and
adapting the next speech prompt based on the user interaction style, wherein the generating the feedback is based on the adapted speech prompt.

3. The method of claim 2, wherein the determining the user interaction style comprises determining a plurality of user interaction styles, and wherein the adapting comprises adapting the feedback based on the plurality of user interaction styles.

4. The method of claim 1, wherein the determining the user interaction style is based on style processing methods that include parameters that are associated with interactive styles.

5. The method of claim 3, wherein the parameters are predefined.

6. The method of claim 3, wherein the parameters are learned from other speech utterances.

7. The method of claim 1, wherein the user interaction style is at least one of an efficient interaction style and an interactive interaction style.

8. The method of claim 1, wherein the user interaction style is at least one of an aged interaction style and a youth interaction style.

9. The method of claim 1, wherein the user interaction style is at least one of a formal interaction style and an informal interaction style.

10. The method of claim of claim 1, further comprising:
receiving user data indicating at least one of a gesture, an expression, and demographics of a user; and
wherein the determining the user interaction style is further based on the user data.

11. The method of claim 1, further comprising adapting non-speech system feedback based on the interaction style.

12. The method of claim 1, wherein the receiving the first utterance is through a human machine interface module of a vehicle.

13. A system for managing speech dialog of a speech system, comprising:
a first module that receives at least one first utterance from a user of the speech system and that determines a user interaction style based on the at least one first utterance; and
a second module that generates feedback to the user based on the interaction style.

14. The system of claim 13, further comprising:
a third module that determines a next speech prompt based on the first utterance, and wherein the second module adapts the next speech prompt based on the user interaction style, and generates the feedback based on the adapted speech prompt.

15. The system of claim 14, wherein the first module determines a plurality of user interaction styles, and wherein the second module adapts the feedback based on the plurality of user interaction styles.

16. The system of claim 13, wherein the first module determines the user interaction style based on style processing methods that include parameters that are associated with interactive styles.

17. The system of claim 16, wherein the parameters are at least one of predefined and learned from other speech utterances.

18. The system of claim 13, wherein the user interaction style is at least one of an efficient interaction style, an interactive interaction style, an aged interaction style, a youth interaction style, a formal interaction style, and an informal interaction style.

19. The system of claim of claim 13, wherein the first module receives user data indicating at least one of a gesture, an expression, and demographics of a user, and determines the user interaction style further based on the user data.

20. The system of claim 13, wherein the second module adapts non-speech system feedback based on the interaction style.
